(19) United States
(12) Patent Application Publication
(10) Pub. No.: US 2025/0174732 A1
(43) Pub. Date: May 29, 2025

(54) NONAQUEOUS ELECTROLYTE SECONDARY BATTERY

(71) Applicant: Panasonic Energy Co., Ltd., Osaka (JP)

(72) Inventors: Atsushi MIZAWA, Hyogo (JP); Fumikazu MIZUKOSHI, Osaka (JP)

(21) Appl. No.: 18/843,114

(22) PCT Filed: Mar. 6, 2023
(86) PCT No.: PCT/JP2023/008249

§ 371 Date: Aug. 30, 2024

(30) Foreign Application Priority Data
Mar. 11, 2022 (JP) 2022-037995

(51) Int. Cl. H01M 10/0587; H01M 50/107

(52) U.S. Cl. CPC H01M 10/0587; H01M 50/107

(57) ABSTRACT

A nonaqueous electrolyte secondary battery including a wound electrode body, positive electrode mixture layers formed on a positive electrode core body, and a negative electrode plate, negative electrode mixture layers formed on a negative electrode core body, a separator being interposed therebetween. A plurality of first regions, in which an exposure surface of the positive electrode core body is present in the width direction, and a plurality of second regions, in which only a portion where the positive electrode mixture layer is formed on the positive electrode core body is present, are present in the longitudinal direction of the positive electrode plate; the number of the first regions is 4 or more. In a cross-section, only the second region is arranged in positions where the positive electrode plate intersects with a half line starting from the battery center and passes through the winding start end of the positive electrode plate.

### TECHNICAL FIELD

The present disclosure relates to a non-aqueous electrolyte secondary battery.

### BACKGROUND ART

Conventionally, there has been known a non-aqueous electrolyte secondary battery, comprising an electrode assembly having a positive electrode plate and a negative electrode plate wound with a separator interposed therebetween, and an outer can containing the electrode assembly and an electrolyte solution. In recent years, there has been a demand for high input/output of secondary batteries used in electric vehicles or the like. Accordingly, in the non-aqueous electrolyte secondary battery, it is considered to improve battery characteristics by joining four current collector leads (current collector tabs) to four core exposed surfaces where a mixture of the positive electrode plate is removed as in the configuration described in Patent Literature 1.

### CITATION LIST

### Patent Literature PATENT LITERATURE 1: Japanese Unexamined Patent Application Publication No. 2000-243376

### SUMMARY

Incidentally, in the non-aqueous electrolyte secondary battery, the electrode assembly expands and contracts with a charge and discharge cycle and in this cycle, electrode plate deformation, which is bending of electrode plates that constitute the electrode assembly, may occur. Since constraining force does not sufficiently work at a winding start-side end of the positive electrode plate and on the negative electrode that is inside the winding in particular, the electrode plate deformation easily occurs. In addition, in the negative electrode plate present inside the winding of the winding start-side end of the positive electrode plate, a difference of level tends to be generated due to the presence or absence of the positive electrode plate outside the winding. When a portion radially outside the winding start-side end of the positive electrode plate unevenly expands and contracts, the electrode plate deformation easily occurs, and particularly the electrode plate deformation of the positive electrode plate and the negative electrode plate easily occurs in the vicinity of the winding start-side end of the positive electrode plate.

When the positive electrode plate is joined to four or more current collector tabs, a core exposed surface needs to be provided at four or more positions in a longitudinal direction of the positive electrode plate and in this case, charge and discharge is not performed on the respective core exposed surfaces nor on the negative electrode plate facing the core exposed surfaces across a separator. Accordingly, when both the portion having the core exposed surface of the positive electrode plate and the portion not having the core exposed surface of the positive electrode plate are present radially outside the winding start-side end of the positive electrode plate, the portion radially outside the winding start-side end of the positive electrode plate unevenly expands and contracts, so that the electrode plate deformation easily occurs. Moreover, when there is a boundary between the exposed core surface and a mixture layer in some part of the positive electrode plate in a width direction, expansion and contraction also become uneven in the width direction of the positive electrode plate, so that the electrode plate deformation occurs more easily.

It is an advantage of the present disclosure to suppress electrode plate deformation in the configuration of a non-aqueous electrolyte secondary battery where a positive electrode plate is joined to four or more current collector tabs.

A non-aqueous electrolyte secondary battery according to the present disclosure comprises: a winding type electrode assembly formed by winding a positive electrode plate and a negative electrode plate with a separator interposed therebetween, the positive electrode plate having a positive electrode mixture layer formed on both surfaces of a band-shaped positive electrode core, the negative electrode plate having a negative electrode mixture layer formed on both surfaces of a band-shaped negative electrode core; and a cylindrical outer housing can that houses the electrode assembly, in which in a longitudinal direction of the positive electrode plate, there are a plurality of first regions where an exposed surface of the positive electrode core is present in at least a portion in a width direction, and a plurality of second regions where only a portion having the positive electrode mixture layer formed on the positive electrode core is present, and the number of the plurality of the first regions is greater than or equal to 4, and each of the plurality of the first regions is joined to a current collector tab, and only the second regions are arranged at positions where a half-straight line starting from a battery center and passing through a winding start-side end of the positive electrode plate intersects the positive electrode plate in a transverse cross section of the electrode assembly.

In the non-aqueous electrolyte secondary battery according to the present disclosure, in the configuration where the positive electrode plate is joined to four or more current collector tabs, only the second regions are arranged at positions where a half-straight line starting from a battery center and passing through a winding start-side end of the positive electrode plate intersects the positive electrode plate. The second regions are regions where only a portion having the positive electrode mixture layer formed on the positive electrode core is present. Accordingly, since the portion radially outside the winding start-side end of the positive electrode plate evenly expands and contracts, the electrode plate deformation can be suppressed despite the fact that the number of the first regions where the exposed surface of the positive electrode core is present increases to greater than or equal to 4.

### BRIEF DESCRIPTION OF DRAWINGS

FIG. 1 is a sectional view of a non-aqueous electrolyte secondary battery in an axial direction as an example of an embodiment.

FIG. 2 is a perspective view of an electrode assembly constituting the non-aqueous electrolyte secondary battery as an example of the embodiment.

FIG. 3 is a schematic exploded view of a positive electrode plate in an example of the embodiment.

FIG. 4A is a schematic view of a transverse cross section that is perpendicular to the axial direction of the non-aqueous electrolyte secondary battery in an example of the embodiment.

FIG. 4B is a view showing only a plurality of first regions and the outer shape of an outer housing can in FIG. 4A to show center angles θ1 to θ4 of the respective first regions.

FIG. 5 shows views corresponding to FIG. 4 in example 1 and comparative examples 1 to 4 of the non-aqueous electrolyte secondary battery and the results of electrode plate deformation.

FIG. 6 shows transverse sectional views perpendicular to the axial direction of the battery, indicating two electrode plate deformation levels used in evaluation of test results to confirm the electrode plate deformation of the electrode assembly.

### DESCRIPTION OF EMBODIMENTS

Hereinafter, an embodiment of the present invention is described in detail with reference to the accompanying drawings. In the following description, specific shapes, materials, numerical values, directions, and the like are merely examples for easy understanding of the present invention, and therefore can appropriately be changed in matching with specifications of the non-aqueous electrolyte secondary battery. A term “substantially” as used below includes the meaning of completely the same and also substantially the same. Moreover, when a plurality of embodiments or modifications are included in the following description, it is assumed from the beginning that their characteristic portions are combined and used as appropriate.

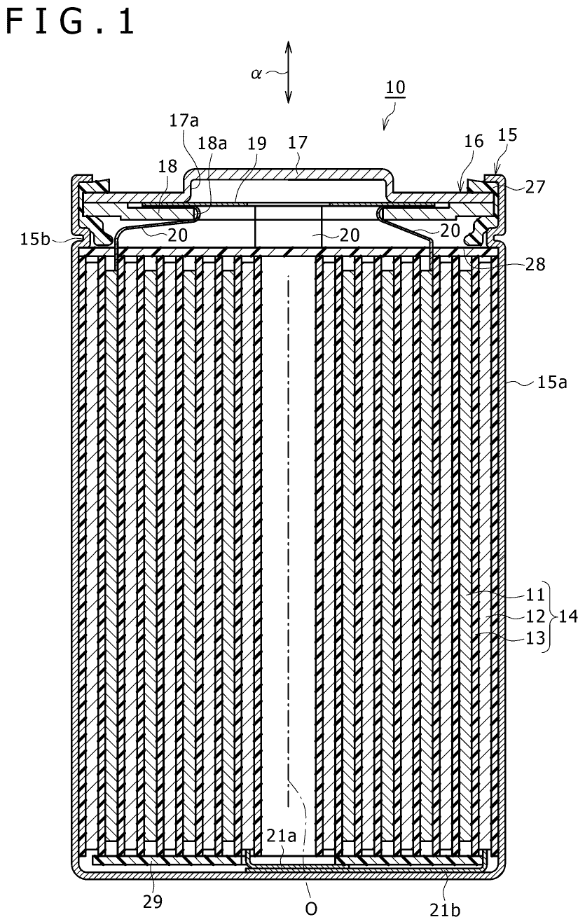

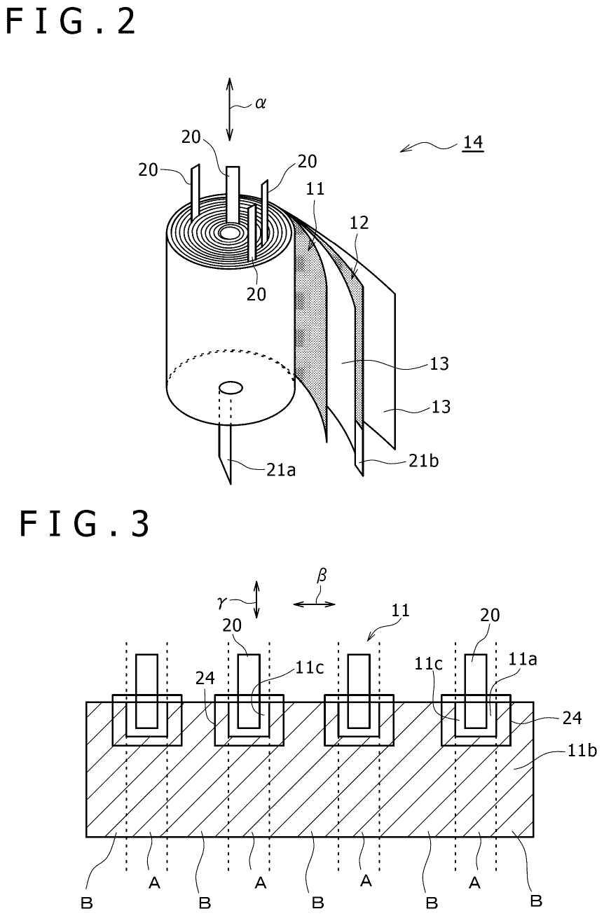

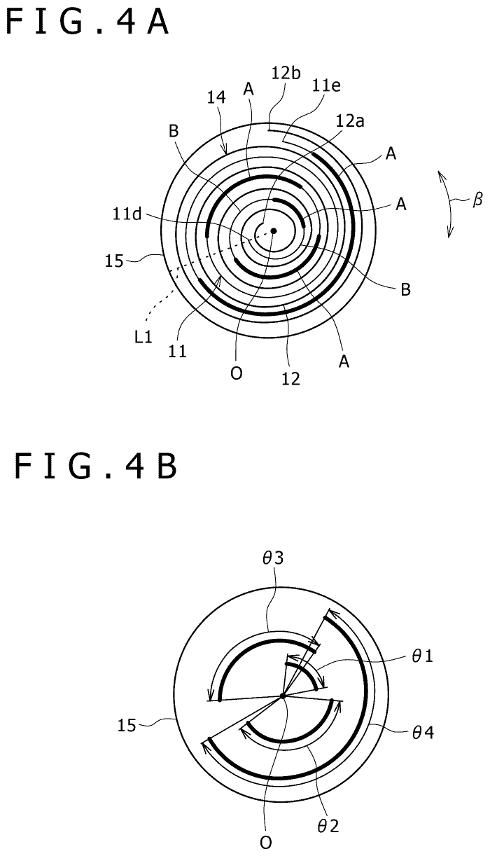

FIG. 1 is a sectional view of a non-aqueous electrolyte secondary battery 10 in an embodiment. FIG. 2 is a perspective view of an electrode assembly 14 constituting the non-aqueous electrolyte secondary battery 10. FIG. 3 is a schematic exploded view of a positive electrode plate 11. FIG. 4A is a schematic view of a transverse cross section that is perpendicular to an axial direction of the non-aqueous electrolyte secondary battery 10. FIG. 4B is a view showing only a plurality of first regions and the outer shape of an outer housing can 15 in FIG. 4A to show center angles θ1 to θ4 of the respective first regions. As shown in FIGS. 1 to 4B, the non-aqueous electrolyte secondary battery 10 comprises the winding type electrode assembly 14, a non-aqueous electrolyte (not shown), the outer housing can 15, and a sealing assembly 16. The winding type electrode assembly 14 has a positive electrode plate 11, a negative electrode plate 12, and a separator 13, with the positive electrode plate 11 and the negative electrode plate 12 being wound in a spiral form with the separator 13 interposed therebetween. In the following description, one axial direction of the electrode assembly 14 may be referred to as “upper” and the other axial direction may be referred to as “lower”. The non-aqueous electrolyte includes non-aqueous solvent and electrolyte salt dissolved in the solvent. The non-aqueous electrolyte is not limited to liquid electrolyte, and may be solid electrolyte using gel-like polymer or the like.

As shown in FIG. 2, the positive electrode plate 11 is joined and electrically connected to four positive electrode tabs 20 that are current collector tabs. Each of the positive electrode tabs 20 is a conductive member that electrically connects a positive electrode core 11a (FIG. 3), constituting the positive electrode plate 11 as described later, to a positive electrode terminal, the conductive member extending from an upper end of the positive electrode core 11a in the electrode assembly 14 to one side (upper side) in an axial direction α.

The negative electrode plate 12 is joined and electrically connected to two negative electrode tabs 21a and 21b. Each of the negative electrode tabs 21a and 21b is a conductive member that electrically connects a negative electrode core constituting the negative electrode plate 12 to a negative electrode terminal, the conductive member extending from a lower end of the negative electrode core in the electrode assembly 14 to the other side (lower side) in the axial direction α. One negative electrode tab 21a is joined to a winding start-side end of the negative electrode plate 12, and the other negative electrode tab 21b is joined to a winding end-side end of the negative electrode plate 12. One of the two negative electrode tabs 21a and 21b may be omitted.

In order to suppress lithium precipitation, the negative electrode plate 12 is formed with dimensions that are one size larger than the positive electrode plate 11 so as to be longer than the positive electrode plate 11 in a longitudinal direction and in a width direction (in a short direction). The two separators 13 are also formed with dimensions at least one size larger than the positive electrode plate 11 and arranged to hold the positive electrode plate 11 therebetween.

With reference to FIG. 3, the positive electrode plate 11 has a band-shaped positive electrode core 11a, and a positive electrode mixture layer 11b formed on both surfaces of the positive electrode core 11a. For the positive electrode core 11a, a foil made of metal such as aluminum, a film having the metal arranged on its surface layer or the like is used, for example. The positive electrode core 11a is preferably a metal foil having aluminum or an aluminum alloy as a main ingredient. The positive electrode core 11a has a thickness of, for example, 10 μm to 30 μm.

The positive electrode mixture layer 11b preferably includes a positive electrode active material, a conductive agent, and a binding agent. The positive electrode plate 11 is produced by applying a positive electrode mixture slurry including a positive electrode active material, a conductive agent, a binding agent, and a solvent such as N-methyl-2-pyrrolidone (NMP) to both the surfaces of the positive electrode core 11a and then drying and rolling the positive electrode core 11a.

Examples of the positive active material may include lithium-containing transition metal oxides that contain transition metal elements, such as Co, Mn, and Ni. Although lithium-containing transition metal oxides are not particularly limited, compound oxides expressed by a general formula Li₁₊ₓMO₂ (in which −0.2<x≤0.2, and M includes at least one of the group consisting of Ni, Co, MN, and Al).

Examples of the conductive agent may include acetylene black (AB), carbon black (CB) such as ketjenblack, and carbon materials such as graphite. Examples of the binding agent may include fluororesin, such as polytetrafluoroethylene (PTFE) and polyvinylidene fluoride (PVdF), polyacrylonitrile (PAN), polyimide (PI), acrylic resin, and polyolefin resin. These resins may be combined with carboxymethylcellulose (CMC) or its salt, polyethylene oxide (PEO) or the like. These materials may be used independently, or two or more kinds may be used combinedly.

As shown in FIG. 3, in a longitudinal direction β of the positive electrode plate 11, there are four first regions A where an exposed surface 11c is present in at least a portion in a width direction γ, the exposed surface 11c being an exposed surface of the metal constituting the positive electrode core 11a, and five second regions B where only a portion having the positive electrode mixture layer 11b formed on the positive electrode core 11a is present. The width direction γ of the positive electrode plate 11 coincides with the axial direction α in a winding state (FIG. 1). The first regions A and the second regions B are arranged alternately in the longitudinal direction of the positive electrode plate 11. The exposed surfaces 11c are portions where the positive electrode tabs 20 are connected and where the surface of the positive electrode core 11a is not covered with the positive electrode mixture layer. In FIG. 3, the positive electrode mixture layer 11b is expressed as a shaded area. The four positive electrode tabs 20 are joined to the four exposed surfaces 11c by ultrasonic welding, for example. The positive electrode tabs 20 are covered with an insulating tape 24, as a result of which a short circuit between the positive electrode plate 11 and the negative electrode plate 12 is prevented. The insulating tape 24 preferably covers all the exposed surfaces 11c of the positive electrode core 11a as shown in FIG. 3.

In the example shown in FIG. 3, in each of the first regions A, the exposed surface 11c is provided only at one side end in the width direction, which is an upper end of the positive electrode plate 11, and an area of each of the first regions A other than the exposed surface 11c is covered with the positive electrode mixture layer 11b. Component materials of the positive electrode tabs 20 are not particularly limited. The positive electrode tabs 20 are preferably made of a metal having aluminum as a main ingredient.

Here, in FIG. 3, the four first regions A are shown to have a substantially equal length in the longitudinal direction β of the positive electrode plate 11, though in actuality, as shown in FIGS. 4A and 4B, the lengths of the respective first regions A in the longitudinal direction β are different from each other, and the lengths are gradually larger from the inside of winding toward the outside of the winding. The sum of center angles θ1, θ2, θ3, and θ4 of the four first regions formed at a battery center, that is, the center O of the outer housing can 15, is greater than or equal to 360 degrees. In FIG. 4A, the first regions A of the positive electrode plate 11 are expressed by a thickest line, the second regions B are expressed by a thin line, and the negative electrode plate 12 is expressed by a line with a thickness between the thicknesses of the lines indicating the regions A and B.

At the more inside of winding than a winding start-side end 11d of the positive electrode plate 11, a winding start-side end 12a of the negative electrode plate 12 extends to a winding start side. At the more outside of winding than a winding end-side end 11e of the positive electrode plate 11, a winding end-side end 12b of the negative electrode plate 12 extends to the winding end side. In FIG. 3, illustration of the separators is omitted. An actual winding numbers of the positive electrode plate 11 and the negative electrode plate 12 are much larger than those shown in FIGS. 1 and 4A.

In addition, in the transverse cross section of the electrode assembly 14 shown in FIG. 4A, only the second regions B, that is, the regions where only the portion having the positive electrode mixture layer 11b formed on the positive electrode core 11a is present, are arranged at positions where a half-straight line (a line expressed by a dashed line L1 in FIG. 4) intersects the positive electrode plate 11, the half-straight line extending through the winding start-side end 11d of the positive electrode plate 11 from the battery center O. In other words, on the above half-straight line, there are no exposed surfaces 11c of the positive electrode core 11a. As a result, the electrode plate deformation can be suppressed in the configuration where the positive electrode plate 11 is joined to the four or more positive electrode tabs 20 as will be described later.

The negative electrode plate 12 has a band-shaped negative electrode core and a negative electrode mixture layer formed on both surfaces of the negative electrode core. For the negative electrode core, a foil of metal such as copper, a film having the metal arranged on its surface layer or the like is used, for example. The negative electrode core has a thickness of, for example, 5 μm to 30 μm.

The negative electrode mixture layer preferably includes a negative electrode active material and a binding agent. The negative electrode plate 12 is produced by, for example, applying a negative electrode mixture slurry, including a negative electrode active material, a binding agent, and water, to both the surfaces of the negative electrode core and then drying and rolling the negative electrode core.

The negative electrode active material is not particularly limited as long as lithium ions can be absorbed and released reversibly. For example, carbon materials such as natural graphite, artificial graphite, metals alloyed with lithium, such as Si and Sn, or alloys containing these, composite oxides, and the like, can be used. For the binding agent included in a negative electrode active material layer, the same resin as used in the positive electrode plate 11 may be used, for example. In the case of preparing the negative electrode mixture slurry with an aqueous solvent, styrene-butadiene rubber (SBR), CMC or its salt, polyacrylic acid or its salt, polyvinyl alcohol, or the like, may be used. These materials may be used independently, or two or more kinds may be used combinedly.

For the separator 13 (FIGS. 1 to 2), a porous sheet with ion permeability and insulation properties is used. Specific examples of the porous sheet may include microporous thin films, woven fabrics, and non-woven fabrics. As the materials of the separator 13, olefin resin such as polyethylene and polypropylene is preferable. The separator 13 has a thickness of, for example, 10 μm to 50 μm. The separator 13 tends to become thinner as the capacity and output of batteries become higher. The separator 13 has a melting point of about 130° C. to 180° C., for example.

On an outermost circumferential surface of the separator 13 that is the outermost circumferential surface of the electrode assembly 14, a tape (not shown) is stuck to the outermost circumferential surface of the separator 13 so as to secure a winding end-side end E of the separator 13.

In the example shown in FIG. 1, the outer housing can 15 and the sealing assembly 16 constitute a metal battery case that houses the electrode assembly 14 and the non-aqueous electrolyte. The sealing assembly 16 is formed such that a sealing plate 17 that is a metal terminal cap on the upper side and a metal current collector plate 18 on the lower side having through-holes 18a are stacked in an up-down direction with a metal plate 19 interposed therebetween. The sealing plate 17 is in a hat-shape having a short cylindrical portion 17a at the center, the short cylindrical portion 17a being molded so as to bulge upward and having a bottomed cylindrical shape. The outer housing can 15 has an annular grooved portion 15b formed on the radial inside of an upper end portion of the cylindrical portion 15a by recessing the upper end portion toward the radial inside over the entire circumference. The sealing assembly 16 is fitted to the inside via a gasket 27 through an opening at the upper end of the cylindrical portion 15a, and the upper end portion of the cylindrical portion 15a is crimped to the radial inside while being engaged with the upper surface of the grooved portion 15b. As a result, the sealing assembly 16 is fixed by crimping to the inside of the opening end of the outer housing can 15 via the gasket 27 on the outer circumferential side.

The electrode assembly 14 is provided with insulating plates 28 and 29 on the upper and lower sides, respectively. The four positive electrode tabs 20 extend toward the sealing assembly 16 through through-holes of the upper insulating plate 28, extend through the through-holes 18a of the current collector plate 18, and are interposed and joined between the current collector plate 18 and an outer circumferential portion of the metal plate 19. In the non-aqueous electrolyte secondary battery 10, the sealing plate 17 that is electrically connected to the current collector plate 18 and the metal plate 19 serves as a positive electrode terminal.

Out of the two negative electrode tabs 21a and 21b, one negative tab 21a, joined to the winding start-side end of the negative electrode plate 12, passes through a through-hole in the lower insulating plate 29 and is then bent substantially at a right angle toward the battery center O so as to extend to the opposite side with respect to the battery center O. Out of the two negative electrode tabs 21a and 21b, the other negative tab 21b, joined to the winding end-side end of the negative electrode plate 12, passes outside of the lower insulating plate 29 and is then folded so as to be overlapped with the one negative electrode tab 21a. An overlapped portion of each of the negative electrode tabs 21a and 21b is joined to an inner surface of the bottom of the outer housing can 15. This allows each of the negative electrode tabs 21a and 21b to be electrically connected to the outer housing can 15 serving as a negative electrode terminal.

According to the above non-aqueous electrolyte secondary battery 10, in the configuration where the positive electrode plate 11 is joined to the four positive electrode tabs 20, only the second regions B are arranged at positions where the half-straight line starting from the battery center O and passing through the winding start-side end 11d of the positive electrode plate 11 intersects the positive electrode plate 11. As a consequence, in the secondary battery 10, although the number of the first regions A where the exposed surface 11c of the positive electrode core 11a is present increases to greater than or equal to 4, there is no exposed surface 11c of the positive electrode core 11a at positions where the above half-straight line intersects the positive electrode plate 11, i.e., there is only a mixture layer forming portion of the positive electrode plate 11 at the positions. Therefore, outside the winding start-side end 11d of the positive electrode plate 11 in the radial direction of the battery, the positive electrode plate 11 and the negative electrode plate 12 tend to evenly expand and contract. Therefore, even though many positive electrode tabs 20 are joined to the positive electrode plate 11, the electrode plate deformation can be suppressed.

According to the above non-aqueous electrolyte secondary battery 10, even though the sum of center angles of the plurality of first regions A formed at the battery center O is greater than or equal to 360 degrees, only the second regions B are arranged radially outside the winding start-side end 11d of the positive electrode plate 11, so that a significant effect of suppressing the electrode plate deformation is obtained.

According to the above non-aqueous electrolyte secondary battery 10, even though at least some of the first regions A include the exposed surface 11c only in one side of the positive electrode plate 11 in the width direction and this causes uneven expansion and contraction of the positive electrode plate in the width direction, a significant effect of suppressing the electrode plate deformation is obtained.

### Example

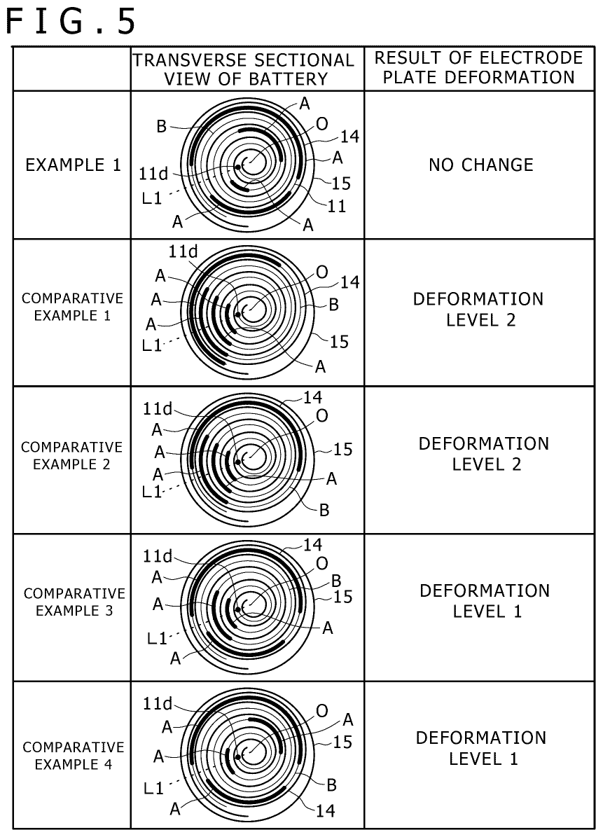

The inventor of the present disclosure produced total five types of secondary batteries in example 1 and comparative examples 1 to 4 under conditions shown in FIG. 5, and performed charge and discharge under prescribed conditions to confirm the degree of electrode plate deformation. FIG. 5 shows the transverse cross sections of the respective secondary batteries and the results (levels) of electrode plate deformation.

### EXAMPLE

### Example 1

### Production of Positive Electrode Plate

As a positive active material, lithium nickel cobalt oxide containing aluminum, expressed by LiNi_{0.88}Co_{0.09}Al_{0.03}O₂, was used. Then, LiNi_{0.88}Co_{0.09}Al_{0.03}O₂ of 100 parts by mass, acetylene black of one part by mass, and polyvinylidene fluoride (PVDF) (binding agent) of 0.9 parts by mass were mixed, and an appropriate amount of N-methyl-2-pyrrolidone (NMP) was added to prepare a positive electrode mixture slurry. Next, the positive electrode mixture slurry in a paste state was applied to both surfaces of a long positive electrode core that was made of an aluminum foil with a thickness of 15 μm, and was dried by a dryer so as to form core exposed surfaces for welding the four positive electrode tabs 20. Then, the positive electrode core 11a that was applied with the positive electrode mixture slurry and dried was cut into a prescribed electrode size and rolled using a roller to produce the positive electrode plate 11 having the positive electrode mixture layer 11b formed on both the surfaces of the positive electrode core 11a. At the time, the positive electrode plate 11 was 0.144 mm thick, 62.6 mm wide, and 861 mm long. The positive electrode tabs 20 made of aluminum were fixed by welding to all the exposed surfaces 11c of the core at four positions in the longitudinal direction of the positive electrode plate 11.

### Production of Negative Electrode Plate

As a negative electrode active material, a mixture of graphite powder of 95 parts by mass and silicon oxide of 5 parts by mass was used. Then, the negative electrode active material of 100 parts by mass was mixed with styrene-butadiene rubber (SBR) of 1 part by mass as a binder and carboxymethyl cellulose (CMC) of 1 part by mass as a thickener. The mixture was then dispersed in water to prepare a negative electrode mixture slurry. The negative electrode mixture slurry was applied to both the surfaces of a negative electrode core made of copper foil with a thickness of 8 μm, dried by a dryer, and was compressed into a prescribed thickness by the roller of a roll press. Then, a long-shaped negative electrode core with the negative electrode mixture layer formed thereon was cut into a prescribed electrode size to produce the negative electrode plate 12 having the negative electrode mixture layer formed on both the surfaces of the negative electrode core. At the time, the negative electrode plate 12 was 0.160 mm thick, 64.2 mm wide, and 959 mm long. Then, at one end of the negative electrode plate 12 in the longitudinal direction that is also an end portion positioned on the winding end side of the electrode assembly 14, an exposed portion was provided where the surface of a current collector was exposed without the presence of the mixture layer, and the exposed portion was attached with the negative electrode tab 21b made of nickel by welding.

### Production of Electrode Assembly

The produced positive electrode plate 11 and negative electrode plate 12 were wound in a spiral shape with the separator 13, constituted of a microporous film that is made of polyethylene, interposed therebetween to produce the winding type electrode assembly 14, and the winding end-side end was secured with a tape.

### Preparation of Non-Aqueous Electrolyte Solution

A vinylene carbonate (VC) of 5 parts by mass was added to a mixed solvent of 100 parts by mass that was formed by mixing ethylene carbonate (EC) and dimethyl carbonate (DMC) with a volume ratio of EC:DMC=1:3, and the mixed solvent was dissolved so that LiPF₆ was 1.5 mol/liter to produce a non-aqueous electrolyte solution.

### Production of Secondary Battery

The above electrode assembly 14 was housed in the bottomed cylindrical outer housing can 15, the insulating plates 28 and 29 were arranged on the upper and lower side of the electrode assembly 14, respectively, and the non-aqueous electrolyte solution was injected into the outer housing can 15 by depressurizing method. The sealing assembly 16 was then fixed to the opening end of the outer housing can 15 via the gasket 27 by cramping to produce the cylindrical non-aqueous electrolyte secondary battery 10. At the time, the battery capacity was 4600 mAh.

In example 1 as shown in FIG. 5, only the second regions B were arranged at positions where the half-straight line L1 extending from the battery center O to the winding start-side end 11d of the positive electrode plate 11 intersects the positive electrode plate 11 in the transverse cross section of the battery. In FIG. 5, the winding start-side end 11d is expressed by a black circle.

### Comparative Example 1

In comparative example 1 as shown in FIG. 5, all the four first regions A were arranged at the positions where the half-straight line L1 extending from the battery center O to the winding start-side end 11d of the positive electrode plate 11 intersects the positive electrode plate 11 in the transverse cross section of the battery. In FIG. 5, the first regions A as well as the plurality of second regions B, which are not shown because of the winding number being smaller than the actual number, are also present on the above half-straight line L1 in actuality. In comparative example 1, other configurations are similar to those in example 1.

### Comparative Example 2

In comparative example 2 as shown in FIG. 5, three first regions A were arranged at the positions where the half-straight line L1 extending from the battery center O to the winding start-side end 11d of the positive electrode plate 11 intersects the positive electrode plate 11 in the transverse cross section of the battery. In FIG. 5, the plurality of second regions B are present on the above half-straight line L1 in actuality as in the case of comparative example 1. In comparative example 2, other configurations are similar to those in example 1.

### Comparative Example 3

In comparative example 3 as shown in FIG. 5, two first regions A were arranged at the positions where the half-straight line L1 extending from the battery center O to the winding start-side end 11d of the positive electrode plate 11 intersects the positive electrode plate 11 in the transverse cross section of the battery. In FIG. 5, the plurality of second regions B are present on the above half-straight line L1 in actuality as in the case of comparative example 1. In comparative example 3, other configurations are similar to those in example 1.

### Comparative Example 4

In comparative example 4 as shown in FIG. 5, one first region A was arranged at the position where the half-straight line L1 extending from the battery center O to the winding start-side end 11d of the positive electrode plate 11 intersects the positive electrode plate 11 in the transverse cross section of the battery. In FIG. 5, the plurality of second regions B are present on the above half-straight line L1 in actuality as in the case of comparative example 1. In comparative example 4, other configurations are similar to those in example 1.

### Test Method

Using the non-aqueous electrolyte secondary batteries in above example 1 and comparative examples 1 to 4, constant current charging (CC) was performed with a current of 1380 mA (0.3 It) under the environment of 25° C. until a battery voltage reached 4.2 V, and then constant voltage charging (CV) was performed at a battery voltage of 4.2 V until a current value of 92 mA was obtained. Then, after a 20-minute break, a constant current discharging was performed at a discharge current of 2300 mA (0.5 It), and then a 20-minute break was given. This sequence was defined as a charge and discharge cycle. Using the batteries subjected to such charge and discharge cycle 1000 number of times, constant current charging was performed at 1380 mA (0.3 It), and after the battery voltage reached 4.2 V, constant voltage charging was performed at a battery voltage of 4.2 V with a termination current of 92 mA. Then, cross-sectional observation of the above batteries was carried out at the position where there was the exposed surface 11c of the positive electrode core 11a in the electrode assembly 14 using an X-ray CT apparatus. In the column of the results of the electrode plate deformation in FIG. 5, the level of the electrode plate deformation was divided into two stages.

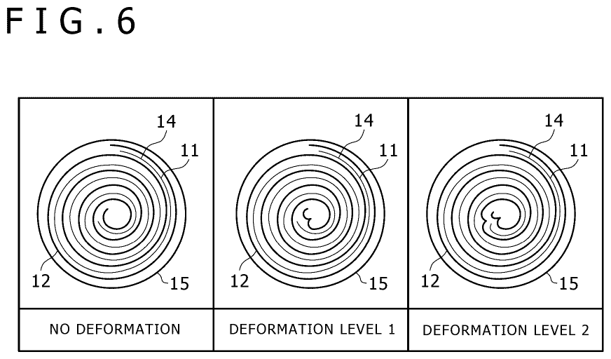

FIG. 6 is a sectional view perpendicular to the axial direction of the electrode assembly 14, showing two levels of the electrode plate deformation used to evaluate the test results for confirming the electrode plate deformation in the electrode assembly 14. Out of the two levels, level 1 of the electrode plate deformation is smaller in the degree of deformation and a curved electrode plate deformation occurs only at the innermost circumference of the electrode assembly 14. Out of the two levels, level 2 is larger in the degree of deformation and a sudden bent electrode plate deformation occurs at portions of at least three rounds including the round of the innermost circumference of the electrode assembly 14. In FIG. 6, the outermost circle represents the outer housing can 15, an inner solid curve represents the negative electrode plate 12, and a thin solid curve represents the positive electrode plate 11.

### Test Result

As shown in FIG. 5, no electrode plate deformation was observed in example 1. The electrode plate deformation in comparative examples 1 and 2 was level 2, while the electrode plate deformation in comparative examples 3 and 4 was level 1. Accordingly, as shown in example 1, when only the second regions B, that is, only the portions of the positive electrode core 11a where the positive electrode mixture layer 11b is formed, are arranged at the positions of intersection between the half-straight line L1 and the positive electrode mixture layer 11b, no electrode plate deformation was observed, and the effect of the embodiment was confirmed.

As is clear from the test results of the comparative examples 1 to 4, when there was at least one first region A on the half-straight line L1, the electrode plate deformation was observed, and in the case of comparative examples 1 and 2 where the number of the first regions A on the half-straight line L1 was greater than or equal to 3, it was confirmed that the degree of the electrode plate deformation becomes larger.

Although in the above embodiment, description is given of the case where the number of the first regions A in the longitudinal direction of the positive electrode plate is greater than or equal to 4, the configuration of the present disclosure is applicable to the configuration where the number of the first regions A is greater than or equal to 5.

### REFERENCE SIGNS LIST

10 Non-aqueous electrolyte secondary battery, 11 Positive electrode plate, 11a Positive electrode core, 11b Positive electrode mixture layer, 11c Exposed surface, 11d Winding start-side end, 11e Winding end-side end, 12 Negative electrode plate, 12a Winding start-side end, 12b Winding end-side end, 13 Separator, 14 Electrode assembly, 15 Outer housing can, 16 Sealing assembly, 17 Sealing plate, 17a Short cylindrical portion, 18 Current collector plate, 19 Metal plate, 20 Positive electrode tab, 21a, 21b Negative electrode tab, 24 Insulating tape, 27 Gasket, 28, 29 Insulating plate, A First region, B Second region

1. A non-aqueous electrolyte secondary battery, comprising:
a winding type electrode assembly formed by winding a positive electrode plate and a negative electrode plate with a separator interposed therebetween, the positive electrode plate having a positive electrode mixture layer formed on both surfaces of a band-shaped positive electrode core, the negative electrode plate having a negative electrode mixture layer formed on both surfaces of a band-shaped negative electrode core; and
a cylindrical outer housing can that houses the electrode assembly, wherein
in a longitudinal direction of the positive electrode plate, there are a plurality of first regions where an exposed surface of the positive electrode core is present in at least a portion in a width direction, and a plurality of second regions where only a portion having the positive electrode mixture layer formed on the positive electrode core is present, and the number of the plurality of the first regions is greater than or equal to 4,
each of the plurality of the first regions is joined to a current collector tab, and only the second regions are arranged at positions where a half-straight line starting from a battery center and passing through a winding start-side end of the positive electrode plate intersects the positive electrode plate in a transverse cross section of the electrode assembly.

2. The non-aqueous electrolyte secondary battery according to claim 1, wherein a sum of center angles of the plurality of first regions formed at the battery center is greater than or equal to 360 degrees.

3. The non-aqueous electrolyte secondary battery according to claim 1, wherein
in at least some of the first regions, the exposed surface is present only on one side of the positive electrode plate in the width direction.
